(19) United States
(12) Patent Application Publication
(10) Pub. No.: US 2006/0087238 A1
(43) Pub. Date: Apr. 27, 2006

(54) Plasma display panel

(76) Inventors: Jae-Ik Kwon, Suwon-si (KR); Kyoung-Doo Kang, Suwon-si (KR)

Correspondence Address: Robert E. Bushnell;Suite 300, 1522 K Street, N.W., Washington, DC, 20005-1202, US

(21) Appl. No.: 11/253,721

(22) Filed: Oct. 20, 2005

(30) Foreign Application Priority Data
Oct. 25, 2004 (KR) 10-2004-085394

(51) Int. Cl. H01J 17/49

(52) U.S. Cl. 313/584; 313/582; 313/585

(57) ABSTRACT

A plasma display panel (PDP) with a novel structure. The PDP includes a first substrate, a second substrate arranged facing the first substrate, a plurality of first barrier ribs arranged between the first substrate and the second substrate and adapted to partition a plurality of discharge cells, a plurality of pairs of discharge electrodes arranged to extend in a first direction within the plurality of first barrier ribs, the plurality of pairs of discharge electrodes being adapted to produce a discharge in the plurality of discharge cells, a plurality of phosphor layers arranged within the plurality of discharge cells, and a discharge gas arranged and sealed within the plurality of discharge cells.

### CLAIM OF PRIORITY

This application makes reference to, incorporates the same herein, and claims all benefits accruing under 35 U.S.C. §119 from an application for PLASMA DISPLAY PANEL earlier filled in the Korean Intellectual Property Office on Oct. 25, 2004 and there duly assigned Serial No. 10-2004-0085394.

### BACKGROUND OF THE INVENTION

1. Field of the Invention

The present invention relates to a new structure for a plasma display panel (PDP).

2. Description of the Related Art

Recently, PDPs are grabbing people's attention as a replacement for conventional cathode ray tube (CRT) display devices. In PDPs, a discharge gas is sealed betweem two substrates on which a plurality of electrodes are formed, a discharge voltage applied to the electrodes, and ultraviolet (UV) rays generated by the discharge excite a phosphor formed in a predetermined pattern to form a desired visible image.

In PDPs, visible light generated in the phosphor layers between the two substrates must travel through one of these two substrates to be seen. This is why one of the two substrates is transparent, so that the generated visible light can reach the outside of the display. However, the substrate is not entirely transparent, as electrodes and other layers may be present on the transparent substrate. These other materials tend to block much of the generated visible light, thus reducing luminous efficiency. Therefore, what is needed is a design for a PDP that improves luminous efficiency by eliminating much of the electrodes and other layers from being formed on the substrate through which the visible light travels through to be seen.

### SUMMARY OF THE INVENTION

It is therefore an object of the present invention to provide an improved design for a PDP.

It is also an object of the present invention to provide a design for a PDP that results in improved luminous efficiency.

It is further an object of the present invention to provide a PDP with reduced permanent image sticking.

It is still an object of the present invention to provide a PDP design that can be manufactured by a simple process, resulting in less defects.

These and other objects may be achieved by a PDP that includes a first substrate, a second substrate arranged facing the first substrate, a plurality of first barrier ribs arranged between the first substrate and the second substrate and adapted to partition a plurality of discharge cells, a plurality of pairs of discharge electrodes arranged to extend in a first direction within the plurality of first barrier ribs, the plurality of pairs of discharge electrodes being adapted to produce a discharge in the plurality of discharge cells, a plurality of phosphor layers arranged within the plurality of discharge cells, and a discharge gas arranged and sealed within the plurality of discharge cells. The plurality of discharge electrodes are arranged in stripes. The plurality of first barrier ribs comprise a plurality of first barrier rib units arranged to face one another. Here, each of the plurality of pairs of discharge electrodes extend along the plurality of first barrier rib units.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is an exploded perspective view of a PDP;

FIG. 2 is an exploded perspective view of a PDP according to an embodiment of the present invention;

FIG. 3 is a cross-sectional view of the PDP of FIG. 2 taken along the line III-III; and

FIG. 4 is a schematic diagram of discharge cells and discharge electrodes of the PDP of FIG. 2.

### DETAILED DESCRIPTION OF THE INVENTION

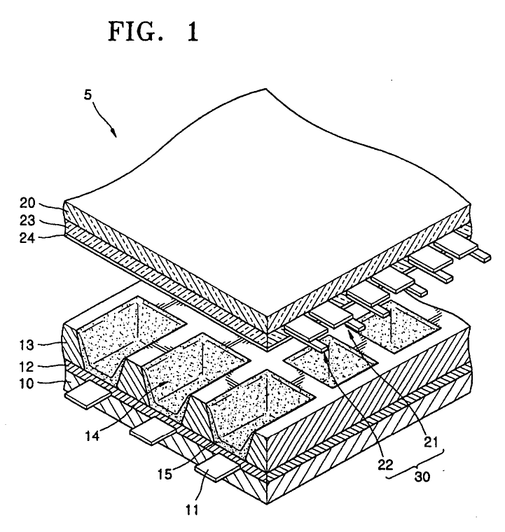

Referring now to the figures, FIG. 1 is a view of a PDP 5. As illustrated in FIG. 1, PDP 5 includes a rear substrate 10 and a front substrate 20 facing each other. A plurality of address electrodes 11 are formed on a top surface (surface facing front substrate) of the rear substrate 10. The address electrodes 11 are covered by a first dielectric layer 12. Barrier ribs 13 partition a space between the first dielectric layer 12 on the front substrate 20 and the rear substrate 10 into a plurality of discharge cells 14, preferably having a matrix design. Phosphor layers 15 are coated to a predetermined thickness within the discharge cells 14 partitioned by the barrier ribs 13. The front substrate 20 is a transparent substrate through which visible light can be transmitted, and is usually made of glass. The front substrate 20 is coupled to the rear substrate 10 on which the barrier ribs 13 are formed. On bottom of the front substrate 20, pairs of sustain electrodes 30 that cross the address electrodes 11 are formed. Each pair of the sustain electrodes 30 includes an X electrode 21 and a Y electrode 22. The pairs of sustain electrodes 30 are covered by a transparent second dielectric layer 23, and a protective layer 24 is formed on bottom of the second dielectric layer 23. However, the three-electrode surface discharge type PDP 5 of FIG. 1, much of visible light (about 40%) generated from the phosphor layers 15 is absorbed by the sustain electrodes 30, the first dielectric layer 23, and the protective layer 24, resulting in low luminous efficiency.

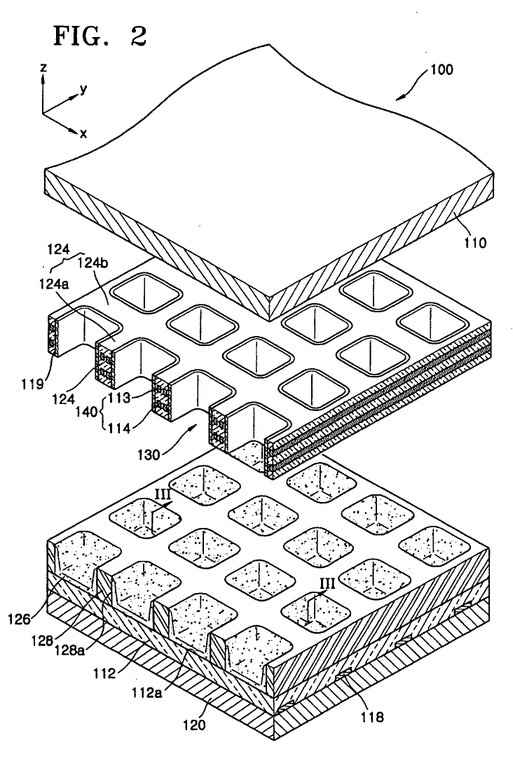

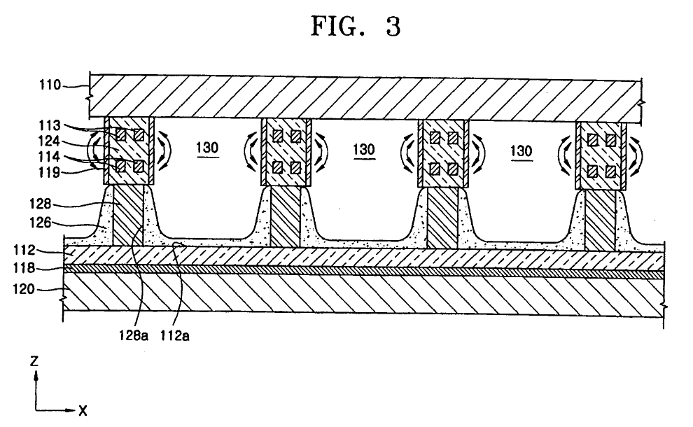

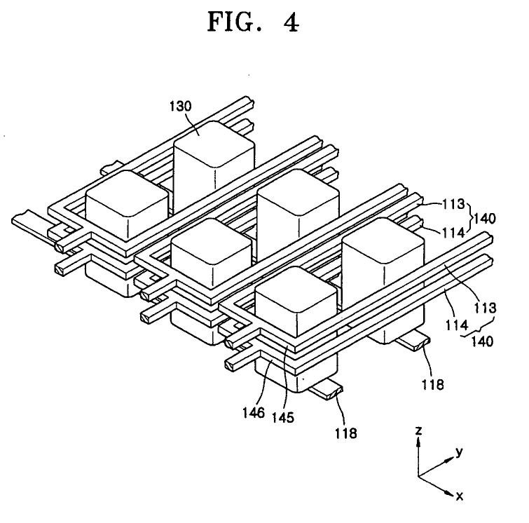

Turning now to FIGS. 2 through 4, FIGS. 2 through 4 are views of a PDP 100 according to an embodiment of the present invention. The PDP 100 of FIGS. 2 through 4 includes a first substrate 110, a second substrate 120, phosphor layers 126, first barrier ribs 124, second barrier ribs 128, pairs of discharge electrodes 140, address electrodes 118, and a dielectric layer 112.

Preferably, the first substrate 110 is manufactured using a material having excellent light transmittance where glass is the main constituent. However, the first substrate 110 can be colored to improve contrast while reducing reflectance luminance. The second substrate 120 is separated by a predetermined distance from the first substrate 110. A plurality of discharge cells 130 partitioned by the first barrier ribs 124 are located between the first and second substrates 110 and 120. The second substrate 120 is manufactured using a material having excellent light transmittance such as glass. The second substrate 120 can also be colored like the first substrate 110. In the present invention, visible light generated in the discharge cells 130 can be transmitted to the outside via the first substrate 110 and/or the second substrate 120. However, in the present embodiment, visible light generated in the discharge cells 130 is transmitted to the outside via the first substrate 110.

Referring to FIG. 2, the first barrier ribs 124 partition the discharge cells 130 having rectangular cross sections. In the present embodiment, the first barrier ribs 124 include first barrier rib units 124a extending in one direction (Y direction) while facing one another, and second barrier rib units 124b crossing with the first barrier rib units 124a. In particular, in the present embodiment, corners of the first barrier ribs 124 are round to 1) prevent the first barrier ribs 124 from getting damaged when discharge concentrates at the corners of the first barrier ribs 124 and 2) to generate a more even discharge throughout the entire discharge cells 130. However, the shape of the first barrier ribs 124 are not limited to that described above, and can be in any shape, for example, a waffle or delta shape can instead be employed and still be within the scope of the present invention. In addition, instead of being rectangular, the cross-sections of the discharge cells can instead be circular, oval or polygonal, such as triangular or pentagonal.

The first substrate 110 and the first barrier ribs 124 can be formed as a single body, which means that the first substrate 110 and the first barrier ribs 124 cannot be separated from each other without damaging one another. Being formed as a single body in no way implies that the first substrate 110 and the first barrier ribs 124 are formed together in a single process step.

As illustrated in FIGS. 2 through 4, the pairs of discharge electrodes 140 are located within the first barrier ribs 124. Each of the pairs of discharge electrodes 140 include a first discharge electrode 113 and a second discharge electrode 114. Each of the first discharge electrodes 113 and the second discharge electrodes 114 are formed in stripes and extend parallel to each other along the direction (Y direction) within the first barrier rib units 124a. A manufacturing process of the PDP 100 is simplified since the first and second discharge electrodes 113 and 114 are formed in stripes and malfunctions due to disconnection of electrode lines can be reduced.

Two pairs of discharge electrodes 140 are disposed to face each other at opposite ends of the discharge cells 130. The two pairs of discharge electrodes 140 cause surface discharge on two opposing sides of each discharge cell 130. However, the present invention is not limited to this configuration. Instead, one pair of discharge electrodes can be disposed to face each other on opposite sides of each discharge cell 130, and the number of pairs of discharge electrodes can be determined considering, for example, the luminance of PDPs.

The first discharge electrodes 113 and the second discharge electrodes 114 are separated from each other by a predetermined distance taken in the Z direction that is normal to the first and the second substrates 110 and 120. The first discharge electrodes 113 are also disposed closer to the first substrate 110 than the second discharge electrodes 114.

The first discharge electrodes 113 of the two pairs of discharge electrodes 140 disposed per discharge cell 130 can be electrically connected to each other at one end by a first connector 145. Although an electrical signal can be separately supplied per first discharge electrode 113, when the same electrical signal is supplied to both first discharge electrodes 113 during the operation of the PDP 100, the two first discharge electrodes 113 are connected together and to an external signal transmitting element, such as a flexible printed cable (FPC), while being electrically connected to each other. Similarly, the two second discharge electrodes 114 can be electrically connected to each other at one end via a second connector 146.

The pair of first and second discharge electrodes 113 and 114 can be symmetrically formed in order to make the discharge inside each of the discharge cells 130 uniform. Because the discharge electrodes are formed within the barrier ribs as opposed to on the first substrate, the first discharge electrodes 113 and the second discharge electrodes 114 do not reduce transmittance of visible light towards the front of the PDP 100 (Z direction), and thus, can be made of conductive and non-transparent metals such as aluminum or copper. As a result, stable signal transmission is possible because a voltage drop along the length of the PDP is small.

The first barrier ribs 124 can be made of dielectric materials that serve to prevent electric shorting between adjacent first and second discharge electrodes 113 and 114 while inhibiting positive ions or electrons from the plasma from directly colliding with the first and second electrodes 113 and 114 and damaging the same. The first barrier ribs 124 also serve to allow for the accumulation of wall charges by inducing charges.

The address electrodes 118 are disposed parallel to one another and separated from each other by a predetermined distance on the front surface of the second substrate 120 to traverse the discharge cells 130. The address electrodes 118 extend in a direction (X direction) to cross the first and second discharge electrodes 113 and 114 in which they extend. The address electrodes 118 are used to produce an address discharge so that a sustain discharge can easily occur between the first discharge electrodes 113 and the second discharge electrodes 114. Specifically, the address electrodes 118 serve to lower the threshold voltage needed to produce the sustain discharge. The address discharge is a discharge which occurs between a scanning electrode and an address electrode. When the address discharge concludes, positive ions accumulate near the scanning electrode and electrons accumulate near a common electrode, and thus a sustain discharge between the scanning electrode and the common electrode can more easily occur. In the present embodiment, the second discharge electrodes 114, which are closer to the address electrodes 118 than the first discharge electrodes 113, can serve as the scanning electrodes. The first discharge electrodes 113, being further from the address electrodes 118 than the second discharge electrodes 114, can act as common electrodes because address discharge occurs most efficiently when the distance between the scanning electrode and the address electrode is minimized. However, the present invention is not so limited to this case arrangement, and the address electrodes 118 can instead be disposed in other various locations.

The address electrodes 118 can be covered by the dielectric layer 112. The dielectric layer 112 is made of a dielectric material that prevents damage to the address electrodes 118 caused by positive ions and charges colliding with the address electrodes 118 during discharge. The dielectric layer 112 also serves to induce charges. The dielectric material can include PbO, B₂O₃, SiO₂, etc.

The second barrier ribs 128, which partition the discharge cells 130 together with the first barrier ribs 124, are disposed between the dielectric layer 112 on the second substrate 120 and the first barrier ribs 124. Although the second barrier ribs 128 are formed in the same shape as the first barrier ribs 124, the second barrier ribs 128 can be formed to have different shapes.

Phosphor layers 126 are also formed on side walls 128a of the second barrier ribs 128 and on top surfaces 112a of the dielectric layer 112. The phosphor layers 126 include material that emits visible light when exposed to ultraviolet (UV) rays. Red color emitting phosphor layers are formed in red discharge cells and include a phosphor material such as Y (V, P) O₄:Eu, green color emitting phosphor layers are formed in green discharge cells and include a phosphor material such as Zn₂SiO₄:Mn, and blue color emitting phosphor layers are formed in blue discharge cells and include a phosphor material such as BAM:Eu.

Protective layers 119 are formed on side walls of the first barrier ribs 124. The protective layers 119 serve to prevent damage to the first barrier ribs 124 that are made of dielectric materials caused by sputtering of plasma particles. The protective layers 119 also serve to lower a discharge voltage by emitting secondary electrons during plasma discharge and serves to increase discharge amount. The protective layers 119 can be formed by spreading magnesium oxide (MgO) to a predetermined thickness. The protective layers 119 are formed as thin films and are applied by sputtering or by an e-beam evaporation method.

A discharge gas, such as Ne or Xe or a combined gas of Ne and Xe, is sealed within the discharge cells 130. In the case of the present invention including the present embodiment, the discharge surface is large and the discharge area is large, resulting in an increased amount of plasma, allowing for low voltage driving. Therefore, in the case of the present invention, even when a high concentration of Xe is present in the discharge gas, low voltage driving is still possible. As a result, luminous efficiency can be drastically improved. This solves one of the problems of PDPs in which low voltage driving is difficult to achieve when a high concentration of Xe is present in the discharge gas.

An operation of the PDP 100 constructed as above will now be described. An address discharge occurs when an address voltage is supplied between the address electrodes 118 and the 5 second discharge electrodes 114. As the result of the address discharge, a discharge cell 130 where a sustain discharge is to later occur, is selected. When a sustain voltage is applied between the first and second discharge electrodes 113 and 114, sustain discharge occurs by migration of wall charges accumulated near the first and second discharge electrodes 113 and 114. When the energy level of a discharge gas excited during the sustain discharge decreases, UV rays are emitted. The UV rays excite the phosphor layers 126 coated inside the discharge cells 130. When the energy level of the 11 excited phosphor layers 126 is lowered, visible light is emitted. The emitted visible light travels through the first substrate 110 so that a viewer can see.

In the PDP 5 illustrated in FIG. 1, sustain discharge between sustain electrodes 21 and 22 occurs in a horizontal direction, and thus there is a relatively small discharge area. However, sustain discharge of the PDP 100 according to the present invention occurs on both sides of the first barrier ribs 124 separating the discharge cells 130, and thus a discharge area is increased. Furthermore, in the PDP 100 according to the present embodiment, the sustain discharge occurs at an upper portion of the discharge cells 130, and thus, ion sputtering of a phosphor layer caused by charged particles in the PDP of FIG. 1 is prevented since the phosphor layers 126 are located in a lower portion of the discharge cells 130. As a result, even if the same image is displayed for a long time, a permanent image sticking does not occur.

The PDP of the present invention has the following effects. First, the manufacturing process is simplified since the structures of the discharge electrodes are simplified. Second, the brightness and luminous efficiency are improved by increased discharge amount due to increased discharge space. Thus, the PDP can be driven at a low voltage, thus drastically improving luminous efficiency. Third, the PDP can be driven at a low voltage even when a high concentration of Xe gas is used for the discharge gas. Fourth, since the electrodes are not disposed on the front substrate through which visible rays are transmitted but on the side walls of the discharge cells, electrodes with low resistance such as metal electrodes can be used instead of transparent electrodes having high resistance. As a result, the speed of discharge response increases and the PDP can be driven at a low voltage without any distortion of signal waves. Fifth, the electric field created by the voltage applied to the first and second discharge electrodes formed on the side walls of the discharge cell is concentrated at the upper portion of the discharge cell. Thus, the electric field prevents ions created by the discharge from colliding with the phosphor layers even when the discharge occurs for a long time. As a result, a permanent image sticking phenomenon caused by damage to the phosphor layers due to ion sputtering can be essentially prevented. Furthermore, the problem of image sticking when a high concentration of Xe gas is used as the discharge gas, which was considered a serious problem, can be overcome.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A plasma display panel (PDP), comprising:
a first substrate;
a second substrate arranged facing the first substrate;
a plurality of first barrier ribs arranged between the first substrate and the second substrate and adapted to partition a plurality of discharge cells;
a plurality of pairs of discharge electrodes arranged to extend in a first direction within the plurality of first barrier ribs, the plurality of pairs of discharge electrodes being adapted to produce a discharge in the plurality of discharge cells;
a plurality of phosphor layers arranged within the plurality of discharge cells; and
a discharge gas arranged and sealed within the plurality of discharge cells.

2. The PDP of claim 1, wherein the plurality of discharge electrodes are arranged in stripes.

3. The PDP of claim 1, the plurality of first barrier ribs comprise a plurality of first barrier rib units arranged to face one another.

4. The PDP of claim 3, wherein each of the plurality of pairs of discharge electrodes extend along the plurality of first barrier rib units.

5. The PDP of claim 1, wherein a plurality of pairs of discharge electrodes are arranged to correspond to the plurality of discharge cells.

6. The PDP of claim 5, wherein two of said plurality of pairs of discharge electrodes are arranged between each of the plurality of discharge cells.

7. The PDP of claim 1, wherein each of the plurality of pairs of discharge electrodes comprises a first discharge electrode and a second discharge electrode.

8. The PDP of claim 7, wherein the first and second discharge electrodes extend parallel to each other.

9. The PDP of claim 7, wherein the first and second discharge electrodes are separated from each other by a distance in a vertical direction with respect to the first substrate.

10. The PDP of claim 7, wherein the first discharge electrodes arranged about a discharge cell are electrically connected to each other and the second discharge electrodes arranged about a discharge cell are electrically connected to the each other.

11. The PDP of claim 1, further comprising a plurality of address electrodes extending to cross with the plurality of pairs of discharge electrodes.

12. The PDP of claim 11, further comprising a dielectric layer covering the plurality of address electrodes.

13. The PDP of claim 11, wherein the plurality of address electrodes are arranged between the plurality of phosphor layers and the second substrate.

14. The PDP of claim 1, further comprising a plurality of second barrier ribs arranged between the plurality of first barrier ribs and the second substrate, the plurality of second barrier ribs being adapted to partition the plurality of discharge cells together with the plurality of first barrier ribs, wherein the plurality of phosphor layers are arranged at least on side walls of the plurality of second barrier ribs.

15. The PDP of claim 1, further comprising a plurality of protective layers arranged on side walls of the plurality of first barrier ribs.

16. A plasma display panel (PDP), comprising:
a first substrate;
a second substrate arranged facing the first substrate;
a plurality of first barrier ribs arranged between the first substrate and the second substrate and adapted to partition a plurality of discharge cells;
a plurality of pairs of discharge electrodes arranged to extend in a first direction within the plurality of first barrier ribs;
a plurality of phosphor layers arranged within the plurality of discharge cells; and
a discharge gas arranged and sealed within the plurality of discharge cells, each of the plurality of pairs of discharge electrodes comprise a first discharge electrode and a second discharge electrode, wherein each discharge cell comprises two opposite sides, a prong of a first discharge electrode and a prong of a second discharge electrode being arrange on each of said two opposite sides of each discharge cell.

17. The PDP of claim 16, the prongs of the first discharge electrodes at the two opposite sides of each discharge cell being electrically connected to each other.

18. The PDP of claim 16, the prongs of the second discharge electrodes at the two opposite sides of each discharge cell being electrically connected to each other.

19. The PDP of claim 16, the plurality of first barrier ribs comprise a plurality of first barrier rib units, a cross section of each first barrier rib unit comprises prongs of two separate first discharge electrodes and prongs of two separate second discharge electrodes.
